(19) United States
(12) Patent Application Publication
(10) Pub. No.: US 2004/0135042 A1
(43) Pub. Date: Jul. 15, 2004

(54) Stand for mounting and vertically holding bar-shaped parts

(76) Inventors: Klaus Krinner, Strasskirchen (DE); Guenther Thurner, Strasskirchen (DE)

Correspondence Address: Jordan & Hamburg, 122 East 42nd Street, New York, NY, 10168, US

(21) Appl. No.: 10/469,331

(22) PCT Filed: Feb. 14, 2002
(86) PCT No.: PCT/EP02/01566

(30) Foreign Application Priority Data
Feb. 28, 2001 (DE) 10109599.6
Dec. 20, 2001 (DE) 10162940.0

(51) Int. Cl. F16M 13/00

(52) U.S. Cl. 248/158

(57) ABSTRACT

The invention relates to a stand for mounting bar-shaped parts (1) that comprises a stand element (2), which holds the bar-shaped part (1) upright, and a holding element (3) that can be tensioned via a tensioning device (4) for holding the bar-shaped part (1). Said stand also comprises and abutment (6) against which, for the purpose of mounting, the bar-shaped part (1) can be squeezed by the holding element (3). To this end, the abutment (6) has at least two bearing points (9, 10), which are interspaced in a vertical direction and against which the bar-shaped part (1) is placed. By placing, for example, against a U-profile (7), the abutment (6), which is provided in the form of a tubular segment, can be turned at least about an essentially horizontal axis. The tensioning device is connected to the stand element (2) via a base part (5). The stand is particularly advantageous in that by solely tensioning the tensioning device, both the bar-shaped part (1) is pulled against the abutment (6) and the abutment (6) is fixed in its pivotal position with regard to the stand element.

The invention relates to a stand for mounting and vertically holding bar-shaped parts of the introductory-portions of claims 1 and 13.

A stand of this type is known from DE 196 30 691 A1. It is used primarily as a Christmas tree stand. However, other bar-shaped parts, such as flagpoles, holding rods for advice displays at trade fairs and construction sites or the like, as well as large sun umbrellas or market umbrellas can also be held with it. In particular, it is intended to be possible, that even trees, which have not grown straight, can be set up easily and aligned vertically with the known stand. For this purpose, the known stand has a stand element in the form of a ring, which is to be placed on the floor and on which a fastening unit is fastened by means of an upwardly protruding arm and a ball joint. The ball joint is arrested with a special locking screw. The fastening unit of the known stand has an abutment of two toothed supports, which are disposed in pairs one above the other, at an angle to one another and at a distance from one another, and a holding element is provided in the for of a tensioning hook, which, by means of a tensioning device, pulls the bar-shaped part, which is to be clamped, against the supports and fastens it by clamping. Subsequently, the fastened, bar-shaped part can be aligned by means of the ball joint until an exactly vertical position is reached. This is advantageous particularly when trees are set up, which have not grown straight.

It is a disadvantage of the known stand of DE 196 30 691 A1 that the handling is relatively complicated, because the clamping device and the locking screw of the ball joint must be actuated separately from one another and consecutively. Moreover, the bar-shaped part must be held hanging until it is clamped by the clamping device against the abutment. In many cases, a single person therefore, cannot manage the handling of the stand.

A different known stand, with the distinguishing features of the introductory portions of claims 1 and 13 is known from the U.S. Pat. No. 4,699,347. In the case of this stand also, the stand element consists of a ring, which is to be placed on the floor and from which three arms protrude towards the inside and are brought together at a ball joint. The ball joint carries a fastening unit, is fixed in position by a spring and, for adjustment, can be loosened by actuating a foot pedal. The fastening unit has two holding elements in the form of simple belts, which are closed by conventional buckles or locking pins and, by these means, pull the bar-shaped part, which is to be clamped, against a abutment in the form of a vertical, curved plate.

As a result of the belt fastening of the additional foot pedal, the handling of the stand is also inconvenient here or even requires much effort. In addition, the clamping force of the belts is limited.

It is an object of the invention to make available a stand of the type named above, which, while having a simple structure, enables even curved, bar-shaped parts to be clamped and adjusted reliably and can be operated easily even by a person without training.

This objective is accomplished by stands of claims 1 and 13. Advantageous developments are given in the related claims 2 to 12 and 14 to 20.

Owing to the fact that, according to the characterizing part of claim 1, the clamping device is constructed at the same time as an arresting device for the rotatable abutment, the operator needs to actuate only a single device. The bar-shaped part is held against the abutment and the clamping device is then actuated only so far, that the bar-shaped part is held lightly against the abutment, while at the same time, however, the abutment can still be rotated. The axis of rotation of the abutment gives a perpendicular plane, in which the bar-shaped part can be swiveled. At the same time, the bar-shaped part can also still be rotated on the abutment, resulting in a second plane for the bar, in which the latter can be rotated. The two aforementioned planes are at right angles to one another. It can easily be seen that, by rotating the trunk in the two planes perpendicular to one another, an adjustment into any position is readily possible. As soon as the desired position of the bar-shaped part, usually a perpendicular position, is attained, the gripping device is finally tightened. The bar-shaped part is clamped securely to the abutment by this simple actuation and, at the same time, the adjusted position attained is secured reliably. Accordingly, a simple operation is assured by the limitation to only a single clamping and fastening process.

The inventive construction also makes possible a development, for which the abutment can additionally be rotated about a vertical axis.

In accordance with a particularly advantageous, basic, further development, the simple construction aimed for is achieved owing to the fact that the abutment has at least two supporting sites, which are at a distance from one another in the vertical direction, and the holding element is disposed between the supporting sites. The abutment can be formed here by a tubular segment, which is supported rotatably with its tubular outside in a horizontally disposed U-shaped profile. This version can be produced particularly simply and permits the abutment to be rotated about a horizontal axis.

The longitudinal edges of the pipe segment form two supporting sites in the form of knife edges, on which the lower end of the bar-shaped part rests. After the gripping device has been tightened moderately, the bar-shaped part can be rotated easily on the two cutting edges. As a result, the above-mentioned second adjustment plane for the bar-shaped part can be formed structurally particularly easily.

In the aforementioned version, the cylindrically curved outer side of the pipe segment contacts the approximately horizontally extending longitudinal edges of the U-shaped profile. As a result, a slight rotation of the pipe segment is readily possible; however, relatively high clamping forces are required for arresting the abutment reliably during the final tightening of the gripping device. If the inventive stand is handled improperly, it may happen that the bar-shaped part is not clamped sufficiently securely in its adjusted position. Therefore, in accordance with a further, advantageous development, the abutment is formed by a pipe segment, which has at least one annular rib with a trapezoidal cross section around its cylindrically curved outer side. As an annular wedge, this rib engages a trapezoidal, fitting recess, which is provided in a guiding block, rotatably supporting the pipe segment, or in a horizontal, U-shaped profile.

For this development, only the lateral flanks of the peripheral rib of circular cross section of the pipe segment are in contact with the guiding block or the U-shaped profile. As a result of the trapezoidal cross section of the rib and of the recess assigned to it in the guiding block or in the horizontal legs of the U-shaped profile, there is a wedge-shaped interaction, and there is always a distance between the outside of the rib and the base of the associated recess. The peripheral rib of circular section forms, as it were, an annular wedge, which engages the recess only with its inclined side surfaces. As a result, the construction with a single rib, which is then very wide and can be described as a bead, has already proven itself to be very appropriate. A variation of this consists of a series of ribs, disposed side by side and resulting in a very large number of wedge surfaces. The particular embodiment with the peripheral ribs and the recesses, assigned to them, in the guiding block or in the U-shaped profile, ensures that the bar-shaped part is clamped securely in its adjusted position without the need for excessively high clamping forces.

It is, however, also possible to form the abutment by a hemispherical element, the outside of which is supported at the front end of a tubular segment. In this way, the abutment becomes movable in all directions.

The two supporting sites of the abutment, which are at a distance from one another in the vertical direction, are advisably provided with a series of clamping teeth, which are disposed next to one another, so that reliable holding can be achieved especially in the case of bar-shaped parts of a soft material, such as wood.

Particularly advantageous structural possibilities are opened up if, in accordance with a further development, the holding element is passed through the abutment to the gripping device. In that case, it becomes possible, for example, to clamp the abutment by means of a fastening pipe, which is connected with the gripping device, reaches through a vertically extending slot in the abutment and has a holding head covering the slot, the holding element being passed through the fastening pipe and the holding head. As can easily be seen, the securing of the clamping connection between the bar-shaped part and the abutment on the one hand and the abutment with respect to its support on the other can be realized here in a structurally simple manner.

In accordance with the embodiments mentioned above, the bar-shaped part is held laterally only by means of the clamping force exerted by the holding element at the abutment and, with that, at the stand. Accordingly, it is still necessary to hold the bar-shaped part during the fastening process, until the clamping force of the holding element becomes effective. In order to simplify the operation further, provisions are therefore made in accordance with a further development so that the abutment has a downward extending extension, which is constructed as a vertically acting support for the bar-shaped part. For such an embodiment, the operator only has to bring the bar-shaped part between the abutment and the holding element and to support this part with its end face on the downward extending extension. By these means, the operation is simplified significantly.

The above embodiment can be improved even further, owing to the fact that the extension is a part with an L-shaped cross section, the approximately horizontally extending leg of the L being constructed as a supporting plate for the end face of the bar-shaped part.

However, even for the last-mentioned embodiment, the abutment and, with that, also the bar-shaped part are held exclusively laterally by the clamping device at the stand. As a result, it becomes necessary to construct the gripping device, the holding element and the parts connected thereto relatively massively. Nevertheless, it may happen that, when the bar-shaped parts are relatively heavy, the gripping device and the parts, connected thereto, are overloaded.

For this reason, a further, advantageous embodiment has also been considered, according to which a swiveling part, in the form of a tubular or spherical section, is provided as abutment and support and is guided pivotably and supported at a fitted socket part of the gripping device as well as at a fitted bottom socket located at the stand element. For such an embodiment, the swiveling part has a single, constant and continuous outer curvature. It is guided at the socket part, which is connected with the stand element and the clamping device. Furthermore, the swiveling part is guided at the bottom socket, which is located at the stand element. Above all, the bottom socket functions as an additional support, which absorbs the bulk of the weight of the bar-shaped part. In this way, the stress on the gripping device and its connecting parts to the abutment and to the holding element are reduced significantly, so that these can be constructed lighter and also more easily activatable. The continuous, constant outer curvature of the swiveling part, which may be cylindrical or spherical, moreover leads to an aesthetically satisfying outer impression, which may be of decisive importance for many practical applications.

For the various embodiments dealt with up to now, a holding element has been provided between two bearing sites of the abutment, disposed one above the other. The advantage, which is achievable with the invention and according to which only a single gripping and clamping process is required, can, however, also be achieved, if, for example, only a single bearing site is provided in conjunction with two holding elements. This further, inventive solution is given in claim 13. It consist therein that, above and below the abutment, a holding element is disposed, which can be actuated by a gripping device. The holding elements are coupled to one another by a compensating mechanism, which can be rotated about a horizontal axis. The inclination of the bar-shaped component can be changed by rotating the compensating mechanism by means of the holding element. Finally, the gripping device is constructed at the same time as a clamping device for the rotatable compensating mechanism.

Because they are coupled together, the holding elements can be adjusted to different gripping widths by rotating the compensating mechanism. This can be realized easily, particularly for a holding element in the form of wire loops. In the case of these holding elements, which are not set identically, the clamping of the gripping device leading to a swiveling of the bar-shaped part about the bearing site of the abutment as fulcrum. As a result, the position of this part can be adjusted very accurately with respect to the perpendicular. According to the examples dealt with so far, the common fixing in position of the clamping device and the compensating mechanism is also readily possible in the case of the second inventive solution and need not be explained in greater detail.

Accordingly, the compensating mechanism can be configured in the form of a rocker, with which the holding elements can be tilted about a pivot point of the abutment when the hold of the gripping device has been loosened.

A flexible construction of the holding element or elements especially in the form of one or more wire loops, embracing the bar-shaped part, is advantageous for all the examples given so far.

The handling of the stand, so developed, is simplified further if devices in the form of helical springs or tension springs are provided, by means of which the holding element is held in an essentially horizontal, opened loop when the gripping device is loosened. The bar-shaped part is, so to say automatically, always put into an opened loop without significantly complicating the structure of the stand.

However, the inventive stand can also be constructed easily if the holding element is a bracket.

Conventional developments of such stands, such as a pot-shaped seating element as stand element, a stand element with protruding feet or a gripping device with rope ratchet and actuating petal, can be taken into consideration as additional embodiments.

The invention is described in even greater detail in the following by means of examples and taking into consideration the drawings, in which

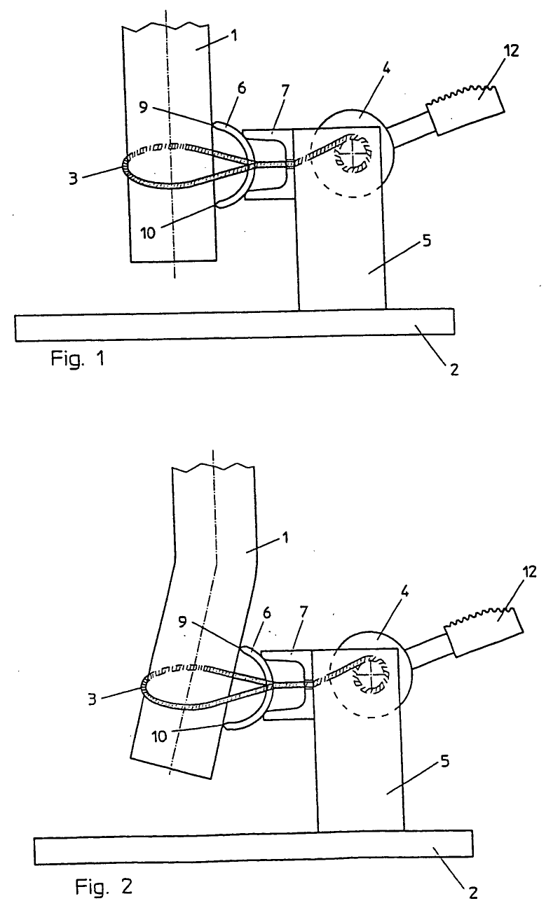

FIG. 1 shows a simplified side view of an inventive stand with a clamped bar-shaped part,

FIG. 2 shows the same view as FIG. 1, the clamped, bar-shaped part, however, being curved,

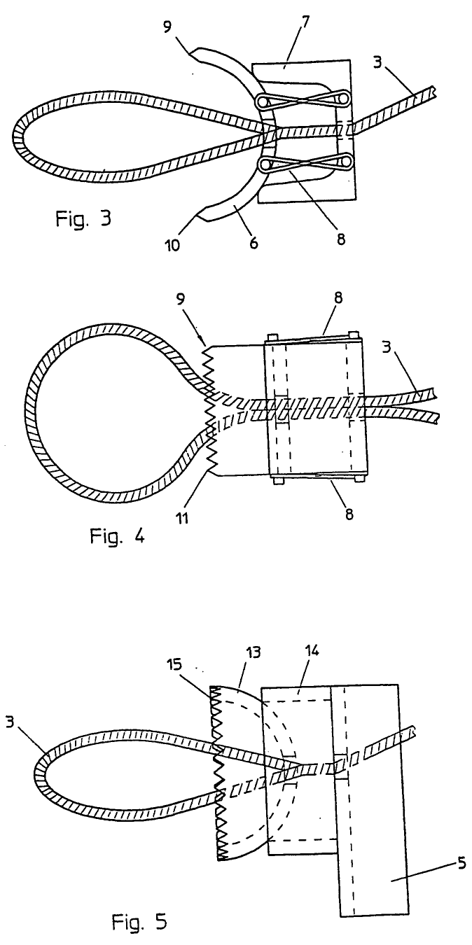

FIG. 3 represents the abutment of the stand of FIGS. 1 and 2 in detail and in a side view,

FIG. 4 is the plan view associated with FIG. 3,

FIG. 5 shows a modified embodiment of the stand of FIGS. 1 to 4,

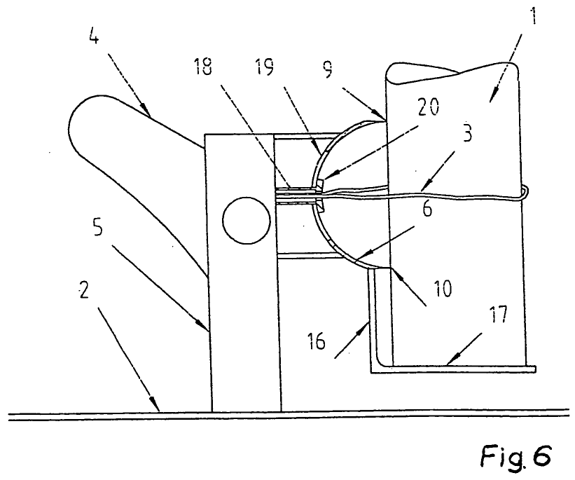

FIG. 6 shows further structural details of the inventive stand,

FIG. 7 shows a further embodiment, for which the abutment and the support of the bar-shaped part are combined into a pivotable part, which is mounted twice,

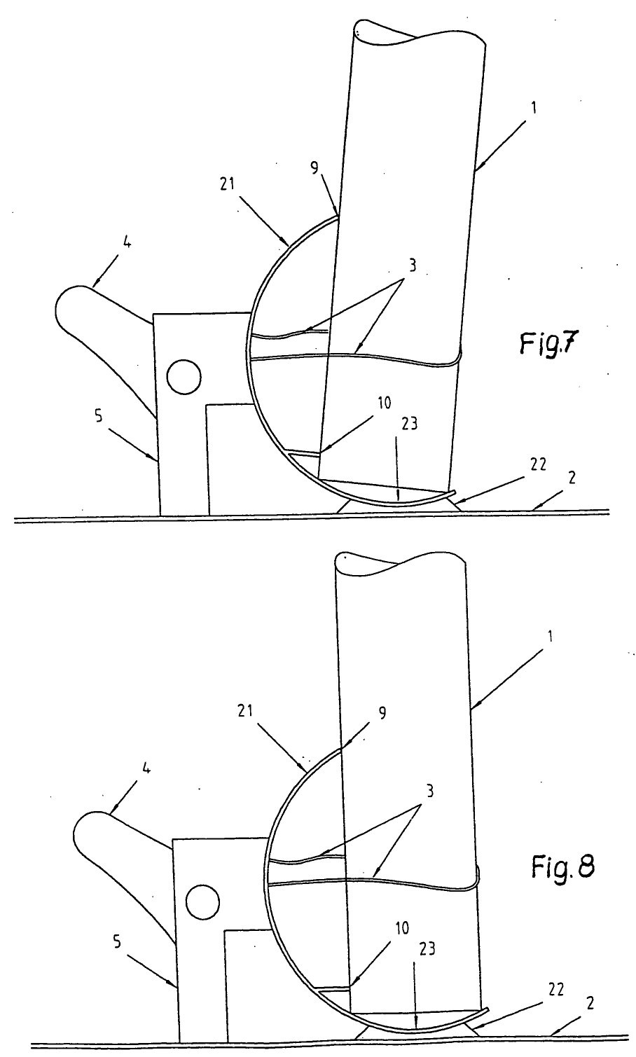

FIG. 8 shows a representation, corresponding to that of FIG. 7, with a different swiveling position of the clamped, bar-shaped part,

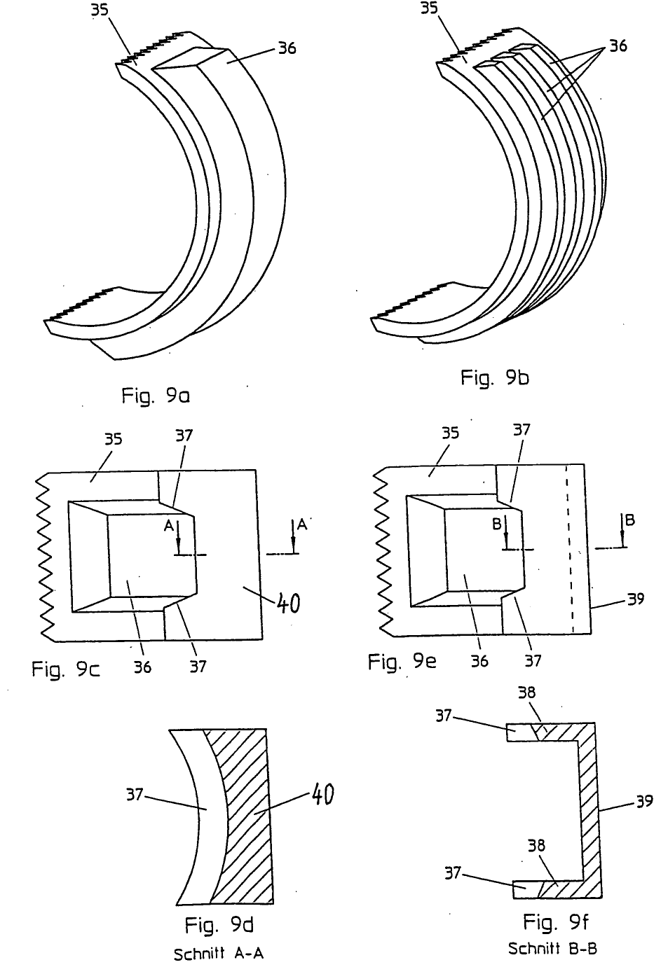

FIG. 9 illustrates a particular construction of the clamping connection between the abutment and the stand element,

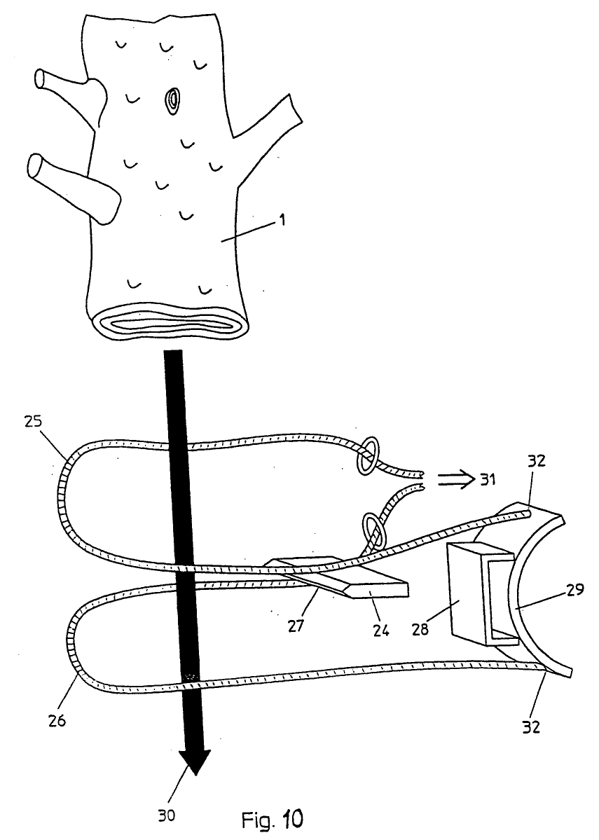

FIG. 10 is a simplified side view of a further embodiment of the inventive stand,

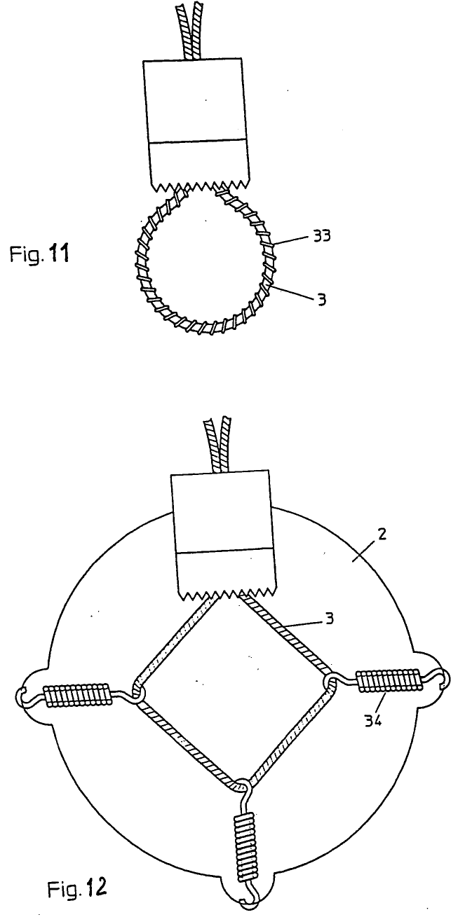

FIG. 11 illustrates, in principle, a device for keeping the wire loop open in the case of the inventive stand and

FIG. 12 shows a further possibility for keeping the wire loop open.

In FIG. 1, the inventive stand is shown in a simplified side view. The stand has a base plate as stand element 2, which carries a gripping device 4 by way of a socket part 5. A pot-shaped part or a cross-shaped stand foot could also be provided instead of a base plate. The gripping device 4 includes a holding element 3 in the form of a wire rope, which is loop-shaped. Furthermore, an abutment 6 is provided which is constructed here as a pipe segment. With its curved side, the pipe segment lies in contact with a U-shaped profile 7, which, in turn, is supported at the socket part 5. The abutment 6 can be swiveled in the U-shaped profile 7, in that it is held, for example, with elastic elements 8 pivotably at the U-shaped profile 7. The details in this connection are given in FIGS. 3 and 4. The holding element 3 is passed through the abutment 6 and the U-shaped profile 7 is passed through the gripping device 4, which is provided with an actuating pedal 12.

The abutment 6, which is constructed as a section of a longitudinally divided cylindrical pipe, forms two bearing surfaces 9 and 10, which can be recognized as pivots in FIGS. 1 and 2, but actually extend linearly. They can be configured as two rows of clamping teeth 11 (FIGS. 3 and 4).

For using the inventive stand, the bar-shaped part 1, which is to be clamped and may, for example, be a Christmas tree, is introduced into the open loop of the holding element 3. The gripping device 4 is then clamped only moderately, so that the abutment 6 can still be swiveled with its cylindrical curvature in the U-shaped profile 7. In this state, the bar-shaped part can be bought very easily into a vertical position. That is advantageous, for example, when the bar-shaped part 1 is curved, as is frequently the case with trees. For this case, FIG. 2 illustrates how the bar-shaped part 1 can be clamped essentially vertically even if the end, which is to be clamped, is curved.

When the rope, forming the holding element 3, is only under a moderate tension, the abutment 6 can easily be rotated with respect to the U-shaped profile 7 about a horizontal axis. With that, a first adjustment plane is formed for the bar-shaped part 1, which is to be clamped, this level corresponding in the present case to the plane of the drawing. In addition, in this clamped state of the holding element 3, the bar-shaped part 1 can still be raised from the abutment 6 by a small amount. Likewise, the abutment 6 can easily be raised by a very small amount from the U-shaped profile 7. Accordingly, the bar-shaped part 1 can also be swiveled while resting on the bearing sites 9 and 10 or on the clamping teeth 11 located thereon, it readily being possible to raise the teeth slightly. With that, the teeth 11 or the bearing sites 9 and 10 form a second vertical plane, which extends perpendicular by to the plane of the drawing and in which the bar-shaped part 1 can also be swiveled. Obviously, by moving the bar-shaped part in two mutually perpendicular planes, an accurate adjustment of the bar-shaped part can be reached.

When the desired position of the bar-shaped part 1 is reached, the gripping device 4 finally is actuated and tightened. By these means, the holding element is pulled through the abutment 6 and the U-shaped profile 7 and pulls or clamps the bar-shaped part 1 against the bearing surfaces 9 and 10, which have been provided with clamping teeth 11. If now the actuating pedal 12 of the gripping device 4 is let go, then not only is the bar-shaped part 1 pulled securely against the abutment 6 and clamped by these means, but also, at the same time, the position, into which the abutment 6 has been swiveled at the U-shaped profile 7, is fixed and secured. This is the particular advantage of the inventive stand, in that, namely, the bar-shaped part 1 is clamped tightly to the abutment as well as arrested in the desired, adjusted position by a single actuating process.

The embodiment of the stand of FIGS. 1 to 4 enables an adjustment to be made, insofar as the abutment can be swiveled about a horizontal axis. In many cases, this will be completely adequate. With the further embodiment of FIG. 5, all around swiveling is achieved in addition. For this purpose, the abutment 6 is constructed in the form of a hemispherical element 13, which lies in contact with a pipe segment 14. The pipe segment 14, in turn, is connected over a socket part 5 with the gripping device 4. Obviously, a bar-shaped part, which is pulled by the holding element 3 against the clamping teeth 15 of the hemispherical element 13, can be swiveled in all directions before the final clamping takes place.

In FIG. 6, further alternatively possible embodiments of the inventive stand are shown. The representation contains, first of all, the stand element 2 with the socket part 5 and the gripping device 4, which is only indicated here and pulls the bar-shaped part 1 by means of the holding element 3 against the abutment 6. The abutment 6 may be a pipe segment here, which interacts with the U-shaped profile 7. Equally well, it may be a hemispherical element, which is connected with a pipe segment, as indicated in FIG. 5.

According to the representation of FIG. 6, the abutment 6 has a downwards leading extension 16, which has an L-shaped cross-section, the approximately horizontally extending leg of the L being constructed as a supporting plate 17 for the end face of the bar-shaped part. With this configuration, it is achieved that, during the clamping and adjusting operations, the bar-shaped part 1 does not catch the bottom of the stand element 2 and does not have to be held by hand at a distance from this bottom. Accordingly, it is ensured that the bar-shaped part 1, reliably connected with the abutment 6, can be swiveled, so that a reliable adjustment can be carried out easily.

Furthermore, FIG. 6 shows a special possibility for fastening the abutment 6 to the socket part 5 and, with that, to the gripping device 4. A fastening pipe 18 has namely been provided, which has, at its side facing the bar-shaped part 1, a holding head 20, which is provided with an opening. The fastening pipe 18 reaches through a slot 19, which extends in the vertical direction in the abutment 6. The holding head 20 of the fastening pipe 18 protrudes over the slot 19 on both sides and, with that, holds the abutment 6 reliably in position. The same fastening principle is also possible when a circular opening is provided instead of a slot 19. Here also, the holding element 3, which is constructed as a wire rope, reaches through the holding head 20 and the fastening pipe 18 and, with that, also the abutment 6. When the gripping device 4 is tightened, the holding element 3 pulls the bar-shaped part 1 against the abutment 6 and, with that, also against the U-shaped profile 7, so that the rotational position of the abutment 6 is locked in place.

In the representation of FIGS. 7 and 8, the inventive stand is shown once again with the stand element 2, the socket part 5 and the gripping device 4, which is only indicated and which clamps the bar-shaped part 1 by means of the holding element 3. In comparison with the previously shown embodiments, the representation of FIGS. 7 and 8 differs in that the abutment, together with a support for the end face of the bar-shaped part 1, is combined into a swiveling part 21, which has a continuous and constant outer curvature, which may be formed, for example, by a cylindrical or spherical surface. Accordingly, the swiveling part 21 consists of a tubular or spherical section, which accommodates the bar-shaped part 1 in its interior. The bearing sites 9 and 10 form the region of the abutment here, whereas the lower section 23 of the swiveling part 21 functions as a supporting plate for the end surface of the bar-shaped part 1.

The swiveling part 21 is guided at two places, namely, on the one hand, at a fitted curvature of the socket part 5 and, on the other, in the bottom socket 22. The weight of the bar-shaped part can be absorbed predominantly here by the bottom socket 22, whereas the abutment, formed by the bearing sites 9 and 10, are used predominantly for clamping the bar-shaped part 1, so that the gripping and clamping force is absorbed in the socket part 5.

The embodiment of FIGS. 7 and 8 accordingly leads to a stand, which can absorb high loads and, moreover, ensures an attractive appearance.

FIGS. 9a to 9f show various possibilities for making further improvements in the clamping connection between the abutment and the U-shaped profile at the socket part. For example, the abutment of FIG. 9a is constructed as a pipe segment 35. However, contrary to the representations of FIGS. 1 to 4, the pipe segment 35 has a peripheral rib 36 here in the form of a circular section and in the nature of a bead, which protrudes to the outside from the cylindrically curved outer side or back side of the pipe segment 35.

Instead of the one bead-like rib, it is also possible to provide several ribs 36, which extend parallel to and at a distance from one another, as indicated in FIG. 9b. In each case, the ribs have a trapezoidal cross section.

According to FIG. 9c, the ribs 36 of the pipe segment, shown in FIG. 9a, engage a guiding block 40, which is at the socket part 5 and in this case forms the abutment. As is evident from FIGS. 9c and 9d, the guiding block 40 has a recess 37 for this purpose, which also has a trapezoidal cross section. The rib 36 acts as an annular wedge and touches the recess only at the inclined surface of the trapezoidal cross section, a gap always remaining at the base of the recess 37. The special embodiment with the peripheral rib 36 and the matching recess 37 ensures that the bar-shaped part is clamped reliably in its adjusted position without requiring excessively high gripping forces for this purpose.

Instead of the guiding block 40, the already mentioned U-shaped profile can also be used for the clamping. In FIGS. 9e and 9f, it has been provided with the reference number 39. The only difference from the embodiment, shown in FIGS. 9c and 9d, is that the recess is formed only by the sections 37 in the horizontal legs 38 of the U-shaped profile 39.

For an embodiment with several ribs 36, several recesses 37 must be disposed likewise in the U-shaped profile 39 or in the guiding block 40. The effect is basically the same.

It is a common feature of the embodiments, which had been discussed, that there is an abutment with two bearing sites 9 and 10, between which the holding element 3 is passed. The embodiment of FIG. 10 shows an arrangement, which deviates from this and for which nevertheless the advantage is retained that the gripping device is constructed at the same time as the clamping device for the adjusted position of the bar-shaped part.

As indicated diagrammatically in FIG. 10, the stand has an abutment 24 with only a single bearing site 27, which is constructed here in the form of a cutting edge. At least in the horizontal direction, the abutment 24 is connected firmly with the stand element of the stand. Above and bellow abutment 24, there are two holding elements 25 and 26, which are constructed here also as wire ropes. The rope-shaped holding elements are passed over a compensating mechanism 29 in the form of a pipe segment, which has fastening sections 32 for this purpose. The compensating mechanism 29 lies against abutment 28. The gripping device of the holding elements 25, 26 is indicated by the arrow 31.

When this embodiment of an inventive stand is used, initially the bar-shaped part 1 is introduced, as indicated by arrow 30, between the loops of the holding elements 26 and 26. If the holding elements 25 and 26 are subsequently tensioned only slightly, the bar-shaped part 1 is gripped at three bearing sites, one of which is formed by the bearing site 27 of the abutment 24, while the other two are formed by the holding elements 25 and 26. The effective length of the upper or lower loop of the holing elements can be increased or decreased by rotating the compensating mechanism 29, so that the bar-shaped part 1 is inclined and swiveled, so to say about the cutting edge of the bearing site 27. If the gripping device subsequently is finally tightened, the bar-shaped part is clamped at the abutment 24 in this position. At the same time, due to the fact that the compensating mechanism 29 lies in contact with the stop 28, the adjusted position of the bar-shaped part 1 is fixed, because the stop 28 acts as a brake for the compensating mechanism.

Alternatively, a rocker with a pivot pin can also be provided for this purpose. It is mounted laterally in elongated holes and, in the case of tensioned holding elements, constructed in the form of wire ropes, clamped in a U-shaped profile with a U-shaped opening, averted from the bar-shaped part 1.

FIGS. 11 and 12 illustrate devices for keeping the loops of the holding elements 3, 25 and 36, formed by wire ropes, open. In FIG. 11, a holding element 3 is passed through an elongated helical spring 33. The helical spring 33 acts as a spiral spring, so that the holding element 3 is held in the form of a loop when the gripping device is loosened.

Alternatively, in simplified form, FIG. 12 shows a device for keeping the loop open. It consists of several helical tension springs 34, which are fastened at the outer periphery of the holding element 3. The helical tension springs 34 are fasted under tension to the stand element 2 of the stand.

If the loops of the rope-shaped holding elements are held open in the manner described, the introduction of the bar-shaped part 1 into the loops is facilitated appreciably. This is a very advantageous if trees are to be clamped.

List of Reference Numbers

1 bar-shaped part 1

2 stand element

3 holding element

4 gripping device

5 socket part

6 abutment (pipe segment)

7 U-shaped profile

8 elastic elements

9 bearing site

10 bearing site

11 clamping teeth

12 actuating pedal

13 abutment (hemispherical element)

14 pipe segment

15 clamping teeth

16 extension

17 supporting plate

18 fastening pipe

19 slot

20 holding head

21 swiveling part

22 bottom socket

23 lower section

24 abutment

25 holding element

26 holding element

27 bearing site

28 stop

29 compensating mechanism

30 arrow

31 arrow

32 fastening section

33 helical spring

34 helical tension spring

35 pipe segment

36 rib

37 recess

38 leg

39 U-shaped profile

40 guiding block

1. Stand for mounting and vertically holding bar-shaped parts (1), with a stand element (2), which is to be placed on the floor, with an abutment (6, 13), which is disposed on the stand element (2) so that it can be rotated at least about one horizontal axis and so that it can be fixed in position, and with a gripping device (4), by means of which a holding element (3) can be actuated, which clamps the bar-shaped part (1) against the abutment (6, 13), characterized in that the gripping device (4) is constructed, at the same time, as a clamping device for the rotatable abutment (6, 13).

2. The stand of claim 1, characterized in that the abutment (13) additionally can be rotated about a vertical axis.

3. The stand of claims 1 or 2, characterized in that the abutment (6, 13) has at least two bearing sites (9, 10), which are at a distance from one another in the vertical direction, and in that the holding element (3) is disposed between the bearing sites (9, 10).

4. The stand of claim 3, characterized in that the abutment (6) is formed by a pipe segment, which is mounted so that it can be rotated with its tubular outer side in a horizontally disposed U-shaped profile (7).

5. The stand of claim 3, characterized in that the abutment is formed by pipe segment (35), the cylindrically curved outer side of which has at its cylindrically curved outer side at least one peripheral rib (36), which is in the shape of a circular section and has a trapezoidal cross-section and, as an annular wedge, engages a trapezoidal, matching recess (37; 37a, 37b), which is placed in a guiding block (40), in which the pipe segment (35) is mounted rotatably, or in a horizontal, U-shaped profile (39).

6. The stand of claims 1 to 3, characterized in that the abutment (13) is formed by a hemispherical element, the outer side of which is mounted at the front end of a pipe segment (14).

7. The stand of one of the claims 3 to 5, characterized in that clamping teeth (11), disposed next to one another in a row, are provided as bearing sites (9, 10).

8. The stand of one of the claims 3 to 7, characterized in that the holding element (3) is passed through the abutment (6, 13) to the gripping device (4).

9. The stand of claim 8, characterized in that the abutment (6, 13) is held by a fastening pipe (18), which is connected with the gripping device (4), reaches through a vertically extending slot (19) into the abutment (6, 13) and has a holding head (20) covering the slot (19), the holding element (3) being passed through the fastening pipe (18) and the holding head (20).

10. The stand of one claims 1 to 9, characterized in that the abutment (6) has a downward league-leading extension (16), which is constructed as a vertically acting support for the bar-shaped part (1).

11. The stand of claim 10, characterized in that the extension (16) is a part with an L-shaped cross section, the approximately horizontally extending leg of the L being formed as a supporting plate (17) for the end face of the bar-shaped part (1).

12. The stand of claim the 11, characterized by a swiveling part (21), which is in the shape of a tubular or spherical section and functions as an abutment and support and which is guided pivotably and supported at a matching socket part (5) of the gripping device (4) as well as at a matching bottom socket (22), located at the stand element (2).

13. Stand for mounting and vertically holding bar-shaped parts (1), with a stand element, which is to be placed on the floor, with an abutment (24), which is disposed at the stand element, and with a gripping device, by means of which the bar-shaped parts (1) can be clamped against the abutment (24), characterized in that one holding element (25, 26) is disposed above and one below the abutment (24), that the holding elements (25, 26) can be actuated by the gripping device and are coupled to one another by a compensating mechanism (29), which can be rotated about a horizontal axis, it being possible to change the slope of the bar-shaped component (1) by means of the holding elements (25, 26), and in that the gripping device is constructed, at the same time, as a device for fixing the rotatable compensating mechanism (29) in position.

14. The stand of claim 13, characterized in that the compensating mechanism is a rocker, with which the holding elements can be tilted about a pivot point of the abutment when the gripping device is loosened.

15. The stand of one of the preceding claims, characterized by a flexible construction of the holding element or elements (3; 25, 26), especially in the form of one or more wire rope loops, which embrace the bar-shaped part (1).

16. The stand of claim 15, characterized in that devices are provided in the form of helical or tensile helical springs (33 or 34) by means of which the holding element (3) is held in an essentially horizontal, opened loops when the gripping device (4) is loosened.

17. The stand of one claims 1 to 14, characterized in that the holding element is a bracket.

18. The stand of one of the preceding claims, characterized in that the stand element is a pot-shaped seating element with a seating space.

19. The stand of one of the claims 1 to 17, characterized in that the stand element is a stand with cross-shaped or star-shaped protruding feet.

20. The stand of one of the preceding claims, characterized in that the gripping device (4) has a rope ratchet with an actuating pedal (12).
